(19) United States
(12) Patent Application Publication
(10) Pub. No.: US 2005/0172826 A1
(43) Pub. Date: Aug. 11, 2005

(54) Primary side power control apparatus for household bean milk and bean curd maker using high capacity switch

(76) Inventor: Hong-bae Kim, Koyang-city (KR)

Correspondence Address: SHLESINGER, ARKWRIGHT & GARVEY LLP;Suite 600, 1420 King Street, Alexandria, VA, 22314, US

(21) Appl. No.: 10/960,753

(22) Filed: Oct. 8, 2004

(30) Foreign Application Priority Data
Oct. 8, 2003 (KR) 2003-31673

(51) Int. Cl. A23L 1/20

(52) U.S. Cl. 99/348

(57) ABSTRACT

Disclosed herein is a primary side power control apparatus for a household bean milk and bean curd maker using a high capacity switch. The power control apparatus includes a projection projecting from a portion of the top of a housing, a high capacity switch that is installed on a portion of a main body opposite to the projection to be turned on or off by the projection and is provided with one end connected to a commercial Alternating Current (AC) power source, a transformer having a primary side connected to the other end of the high capacity switch, and relays connected in parallel to each other between the high capacity switch and the transformer and operated to supply or interrupt power to a drive motor and a heater. Accordingly, the present invention is advantages in that it supplies power through the use of a switch structure resistant to vibration when a main body and a housing are coupled to each other, thus preventing the power from being interrupted during the operation of the maker, and it interrupts power applied to a primary side through the use of a high capacity switch placed on the primary side of a transformer when the main body and the housing are not coupled to each other, thus preventing the occurrence of an electric shock.

### CROSS-REFERENCE TO RELATED APPLICATION

This application claims priority of Korean application no. 2003-31673, filed Oct. 8, 2003, which is incorporated herein by reference.

This application relates to Applicant's concurrently filed U.S. application (applicant's ref. 7397), entitled “Handle-Combined Locking Device for Household Bean Milk and Bean Curd Makers”, filed Oct. 8, 2004.

### FIELD OF THE INVENTION

The present invention relates generally to household bean milk and bean curd makers, and more particularly, to a primary side power control apparatus for a household bean milk and bean curd maker using a high capacity switch, which supplies power through the use of a switch structure resistant to vibration when a main body and a housing are coupled to each other, thus preventing the power from being interrupted during the operation of the maker, and which interrupts power applied to a primary side through the use of a high capacity switch placed on the primary side of a transformer when the main body and the housing are not coupled to each other, thus preventing the occurrence of an electric shock.

### BACKGROUND OF THE INVENTION

A conventional method of making bean milk and bean curd has a problem in that several processes are individually executed, thus it is inconvenient and complicated to make bean milk and bean curd, and it takes longer time to make the bean milk and the bean curd, thereby the conventional method is inefficient.

In order to solve the problems, there have been proposed various devices for easily and conveniently making bean milk and bean curd at home. For example, there are Korean Patent No. 225772, Korean Patent No. 228659, Korean U.M. Registration No. 158856, Korean U.M. Registration No. 250843, etc, that are disclosed by the applicant of the present invention. The Korean Patent No. 225772 was published on Oct. 15, 1999, and is titled “household bean curd maker”. The Korean Patent No. 2000-228659 was published on Mar. 15, 2000, and is titled “household bean curd maker”. The Korean U.M. Registration No. 158856 was registered on Jul. 16, 1999, and is titled “household bean curd maker”. The Korean U.M. Registration No. 250843 was registered on Oct. 5, 2001, and is titled “household bean curd maker with fixed-type blade unit”.

A conventional household bean milk and bean curd maker will be described in the following with reference to the attached drawing.

FIG. 1 is a sectional view of the conventional household bean milk and bean curd maker. As shown in FIG. 1, the conventional household bean milk and bean curd maker includes a housing 1 which has a cavity to contain water therein. A main body 2 is provided on an upper portion of the housing 1 to open or close the housing 1, like a lid. A drive motor 3 is installed in a predetermined portion of the main body 2, and generates rotating power when electricity is applied to the drive motor 3. A drive shaft 4 transmits the rotating power from the drive motor 3. A cutting blade 5 is provided at an end of the drive shaft 4. A rod-shaped heater 6 downwardly extends from the main body 2, and generates heat when electricity is applied to the heater 6, thus heating an interior of the housing 1. A temperature sensing bar 7 detects the temperature of the interior of the housing 1. A filter net 8 is detachably mounted to a predetermined portion of the main body 2, and contains beans therein. Further, the household bean milk and bean curd maker also includes silicone packing 9 which is attached to an underside of the main body 2 at a junction between the main body 2 and the housing 1. The silicone packing 9 functions to prevent leakage of water into the main body 2 and absorb a shock.

The conventional household bean milk and bean curd maker constructed as described above is operated as follows.

First, a user puts water into the housing 1. Beans are put into the filter net 8 which is detached from the main body 2, and then the filter net 8 containing the beans is mounted to the lower portion of the main body 2. Afterwards, the main body 2 is placed on the upper portion of the housing 1 so that the filter net 8 is put into the housing 1.

Next, when a power switch (not shown) is turned on to apply electricity to the household bean milk and bean curd maker, a control unit (not shown) outputs a control signal to operate the heater 6 and the temperature sensing bar 7. At this time, a primary heating process is executed while maintaining a predetermined temperature, for a predetermined period.

When the primary heating process has been completed, the control unit (not shown) outputs a control signal to operate the drive motor 3. As the drive motor 3 is operated, the beans contained in the filter net 8 are ground by the cutting blade 5 provided at the end of the drive shaft 4. While the beans are ground, turbulence of water contained in the housing 1 is caused by rotation of the cutting blade 5. By the turbulence, bean grains which are finely ground by the cutting blade 5 come out of the filter net 8. Thus, the beans ground by the cutting blade 5 are divided into bean-curd dregs which remain in the filter net 8, and the extract of protein which flows out of the filter net 8.

Thereafter, the control unit (not shown) outputs a control signal to operate the heater 6 and the temperature sensing bar 7. At this time, a secondary heating process is executed while maintaining a predetermined temperature, for a predetermined period. Through the above-mentioned process, bean milk is obtained.

When the user desires to make bean curd, the user takes the heated extract of protein out of the housing 1. Next, the coagulant is added to the heated extract of protein so as to coagulate the extract of protein. Thereafter, the coagulated protein is pressed in the frame to produce the bean curd.

However, the conventional household bean milk and bean curd maker is problematic in that, when it is operated while the main body 2 is not completely coupled to the housing 1 on the upper portion of the housing 1, the user may be injured due to the cutting blade 5 being exposed outward.

In order to solve the problem, technology of operating a bean curd maker only after a main body is completely seated on and coupled to a housing is disclosed in Korean U.M. Registration No. 20-0326487 entitled “safety device for bean curd makers”.

However, since the conventional technology uses a scheme of interrupting the power supply using a magnet and a lead switch, there is a problem in that, if space forms between the magnet and the lead switch due to vibration occurring when beans are ground, and the lead switch moves out of the range of magnetic force of the magnet even though power is supplied after the main body and the housing are coupled to each other, power is unexpectedly interrupted during the operation of the bean curd maker.

Further, the conventional technology is problematic in that, since a current capacity is as low as 2 A according to the electrical characteristics of the lead switch, the lead switch is designed to interrupt power applied to the secondary side of a transformer, not power applied to the primary side thereof. In other words, since the lead switch is designed so that it is placed on the secondary side of the transformer, a current continuously flows through the primary side of the transformer even though power is interrupted when the main body and the housing are not coupled to each other, so that the user may experience an electric shock if an electrical circuit is completed due to careless use.

### OBJECTS AND SUMMARY OF THE INVENTION

Accordingly, the present invention has been made keeping in mind the above problems occurring in the prior art, and an object of the present invention is to provide a primary side power control apparatus for a household bean milk and bean curd maker using a high capacity switch, which supplies power through the use of a switch structure resistant to vibration when a main body and a housing are coupled to each other, thus preventing the power from being interrupted during the operation of the maker, and which interrupts power applied to a primary side through the use of a high capacity switch placed on the primary side of a transformer when the main body and the housing are not coupled to each other, thus preventing the occurrence of an electric shock.

### BRIEF DESCRIPTION OF THE DRAWINGS

FIG. 1 is a sectional view of a conventional household bean milk and bean curd maker;

FIG. 2 is a perspective view showing an external shape of a primary side power control apparatus for a household bean milk and bean curd maker using a high capacity switch according to an embodiment of the present invention;

FIGS. 3a and 3b are sectional views showing the construction of a primary side power control apparatus for a household bean milk and bean curd maker using a high capacity switch according to an embodiment of the present invention; and

FIG. 4 is a circuit diagram of a primary side power control apparatus for a household bean milk and bean curd maker using a high capacity switch according to an embodiment of the present invention.

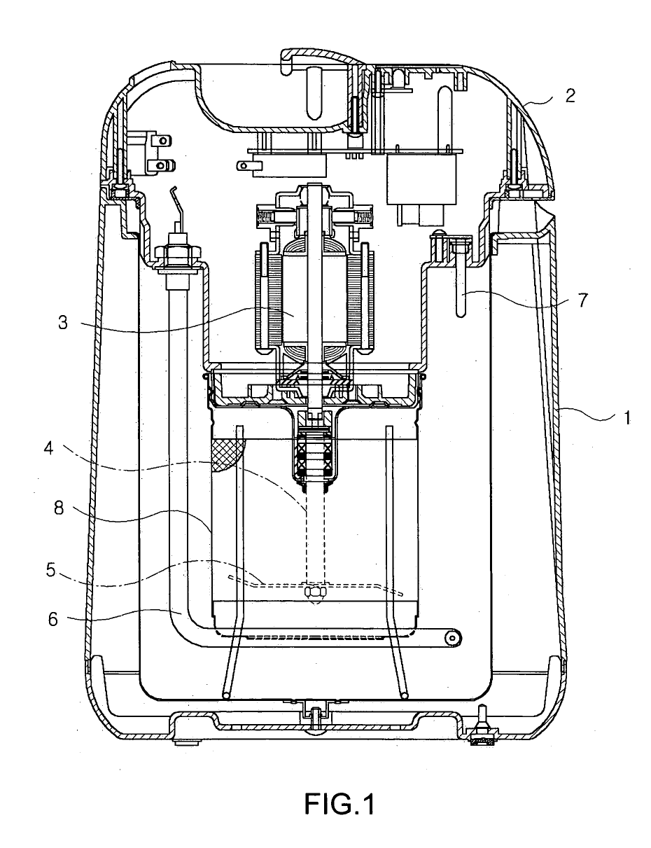

### DETAILED DESCRIPTION OF THE INVENTION

Hereinafter, embodiments of the present invention will be described in detail with reference to the attached drawings. The above and other objects, features and other advantages of the present invention will be more clearly understood from the following detailed description taken in conjunction with the accompanying drawings.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

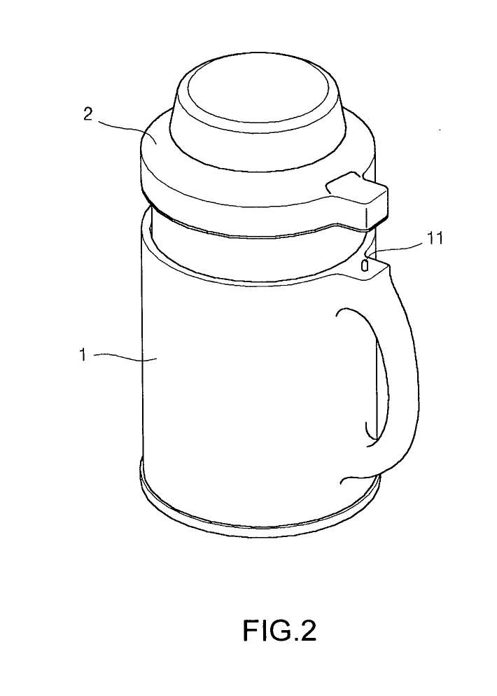

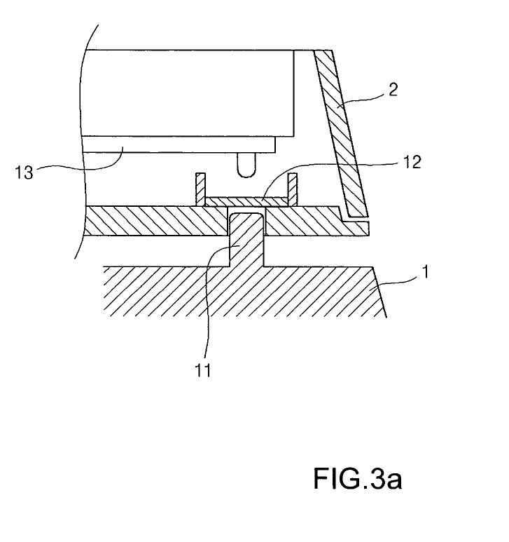

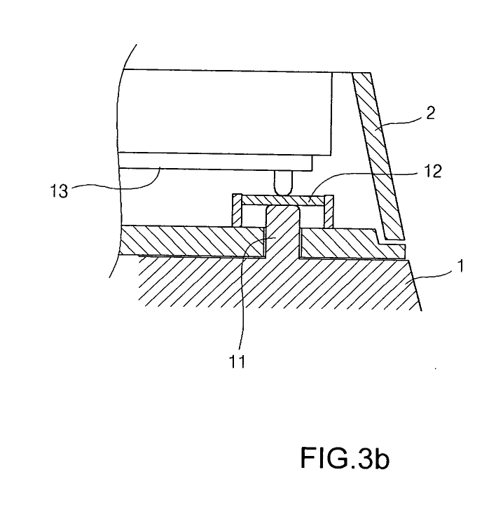

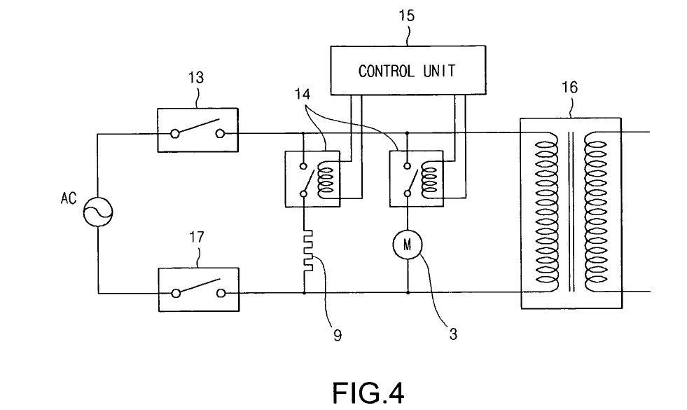

As shown in FIGS. 2 to 4, a primary side power control apparatus for a household bean milk and bean curd maker using a high capacity switch according to an embodiment of the present invention includes a projection 11 that projects from a portion of the top of a housing 1, a high capacity switch 13 that is installed on a portion of a main body 2 opposite to the projection 11 to be turned on or off by the projection 11 and has one end connected to a commercial Alternating Current (AC) power source, a transformer 16 that has a primary side connected to the other end of the high capacity switch 13, and relays 14 that are connected in parallel to each other between the high capacity switch 13 and the transformer 16 and operated to supply or interrupt power to both a drive motor 3 and a heater 9 in response to a control signal output from a control unit 15.

Preferably, the primary side power control apparatus for a household bean milk and bean curd maker using a high capacity switch according to the embodiment of the present invention may further include a second high capacity switch 17 that is installed on a portion of the main body 2 opposite to the high capacity switch 13 with the AC power source being interposed between the high capacity switch 13 and the second high capacity switch 17.

Preferably, the primary side power control apparatus for a household bean milk and bean curd maker using a high capacity switch according to the embodiment of the present invention may further include a push rod 12 placed between the projection 11 and the high capacity switch 13.

The operation of the primary side power control apparatus for a household bean milk and bean curd maker using a high capacity switch according to the embodiment of the present invention, having the above construction, is described below.

When a user couples the main body 2 to the upper portion of the housing 1 to make bean milk or bean curd, the projection 11 projecting from a portion of the top of the housing 1 pushes the push rod 12, and the push rod 12 pushes the high capacity switches 13 and 17 installed on portions of the main body 2 opposite to the projection 11, thus turning on the high capacity switches 13 and 17.

If the high capacity switches 13 and 17 are turned on in this way, commercial AC power is applied to the transformer 16 through the high capacity switches 13 and 17, transformed by the transformer 16, and then transmitted to the secondary side of the transformer 16.

In this case, switches having a high allowable current capacity equal to or greater than 5 A, such as micro switches, are used as the high capacity switches 13 and 17 so that they are placed on the primary side of the transformer 16 through which a relatively high capacity current flows.

If the control unit 15 drives the relays 14 depending on the manipulation of the user after the high capacity switches 13 and 17 are turned on as described above, the commercial AC power is applied to both the drive motor 3 and the heater 9 to operate the drive motor 3 and the heater 9, thus automatically conducting a bean milk and bean curd making process.

At this time, since the high capacity switch 13 is relatively resistant to vibration, it is not turned off during the operation of the drive motor 3, thus preventing the power from being interrupted during the operation. Further, the push rod 12 helps the high capacity switch 13 to remain turned on.

In the meantime, when the main body 2 is not coupled to the upper portion of the housing 1, the high capacity switches 13 and 17 remain turned off. Accordingly, the commercial AC power is not applied to the primary side of the transformer 16 at all, so that the power to be applied to the primary side of the transformer is fundamentally interrupted, thus preventing the possibility of an electric shock.

As described above, the present invention provides a primary side power control apparatus for a household bean milk and bean curd maker using a high capacity switch, which is advantageous in that the power control apparatus supplies power through the use of a switch structure resistant to vibration when a main body and a housing are coupled to each other, thus preventing the power from being interrupted during the operation of the maker, and the power control apparatus interrupts power applied to a primary side through the use of a high capacity switch placed on the primary side of a transformer when the main body and the housing are not coupled to each other, thus preventing the occurrence of an electric shock.

While this invention has been described as having a preferred design, it is understood that it is capable of further modifications, and uses and/or adaptations of the invention and including such departures from the present disclosure as come within the known customary practice in the art to which the invention pertains, and as may be applied to the central features hereinbefore set forth, and fall within the scope of the invention or limits of the claims appended hereto.

1. A primary side power control apparatus for a household bean milk and bean curd maker using a high capacity switch, comprising:
a) a projection projecting from a portion of a top of a household bean milk and bean curd maker housing having a cavity to contain water therein;
b) a first high capacity switch installed on a portion of a main body provided on a top portion of the housing to open and close the housing and opposite to the projection to be turned on or off by the projection, the first high capacity switch having a first end connected to a commercial Alternating Current (AC) power source;
c) a transformer having a primary side connected to a second end of the first high capacity switch; and
d) one or more relays connected in parallel to each other between the first high capacity switch and the transformer, and operated to supply or interrupt power to both a drive motor and a heater in response to a control signal output from a control unit.

2. The power control apparatus according to claim 1, further comprising:
a) a second high capacity switch installed on a portion opposite to the first high capacity switch with the AC power source being interposed between the first and second high capacity switches.

3. The power control apparatus according to claim 2, further comprising:
a) a push rod placed between the projection and the first high capacity switch.

4. The power control apparatus according to claim 1, further comprising:
a) a push rod placed between the projection and the first high capacity switch.
